(19) United States
(12) Patent Application Publication
(10) Pub. No.: US 2024/0239193 A1
(43) Pub. Date: Jul. 18, 2024

(54) INFORMATION PROVISION DEVICE, DISPLAY METHOD, AND NON-TRANSITORY COMPUTER STORAGE MEDIUM

(71) Applicants: TOYOTA JIDOSHA KABUSHIKI KAISHA, Toyota-shi (JP); DENSO CORPORATION, Kariya-city (JP)

(72) Inventors: Yu SASAKI, Tokyo-to (JP); Kazunao YOKOO, Misato-shi (JP)

(73) Assignees: TOYOTA JIDOSHA KABUSHIKI KAISHA, Toyota-shi (JP); DENSO CORPORATION, Kariya-city (JP)

(21) Appl. No.: 18/488,341

(22) Filed: Oct. 17, 2023

(30) Foreign Application Priority Data
Jan. 17, 2023 (JP) 2023-005155

(51) Int. Cl. B60K 35/00; B60R 1/26; G06V 20/58; G06V 20/59

(52) U.S. Cl. CPC B60K 35/00; B60R 1/26; G06V 20/58; G06V 20/59; B60K 2370/149; B60K 2370/152; B60K 2370/171; B60K 2370/176

(57) ABSTRACT

An information provision device includes an information display screen configures to display information to be provided to a driver of a vehicle and a control device configured to control displayed content of the information display screen. The control device detects a positional relationship of the vehicle and an object present in a rear region of the same based on surrounding data showing a situation in the surroundings of the vehicle, detects a line-of-sight direction of the driver based on driver data showing the state of the driver, and displays rear region information including the positional relationship at the information display screen in response to detecting that the driver is viewing a rear check device for checking the rear of the vehicle based on the line-of-sight direction of the driver.

### FIELD

The present disclosure relates to an information provision device, display method, and non-transitory computer storage medium.

### BACKGROUND

Japanese Unexamined Patent Publication No. 2020-201647 discloses a conventional vehicular use display device configured so as to detect an object present in the surroundings of an equipped vehicle and a line of sight of a driver and to display on a display device information on the predicted behavior of an object which the driver is focusing on, that is, an object which a driver can be judged to be interested in.

### SUMMARY

However, in the above-mentioned conventional vehicular use display device, it was only possible to provide the driver with information regarding an object which the driver was focusing on, that is, an object which the driver could check by sight. For this reason, even if the driver checked the rear, if there were an object unable to be recognized due to being missed, there was the problem that information on the object could not be provided to the driver.

The present disclosure was made focusing on such a problem and has as its object the provision of information on an object present in a rear region of a vehicle at a suitable timing when the driver desires to check the rear of the vehicle.

The gist of the disclosure is as follows:
(1) An information provision device comprising an information display screen configured to display information to be provided to a driver of a vehicle and a control device configured to control displayed content of the information display screen, wherein the control device is configured to detect a positional relationship of the vehicle and an object present in a rear region of the vehicle based on surrounding data showing a situation in the surroundings of the vehicle, detect a line-of-sight direction of the driver based on driver data showing the state of the driver, and display rear region information including the positional relationship at the information display screen in response to detecting that the driver is viewing a rear check device for checking the rear of the vehicle based on the line-of-sight direction of the driver.
(2) The information provision device according to the above (1) wherein, after displaying rear region information on the information display screen, the control device is configured to end display of the rear region information in response to detecting that the driver viewed the information display screen based on the line-of-sight direction of the driver or a predetermined time period elapsing after detecting that the driver viewed the information display screen.
(3) The information provision device according to the above (1) or (2) wherein rear region information includes information relating to the type of the object.
(4) The information provision device according to any of the above (1) to (3) wherein the surrounding data is an image of the rear region of the vehicle captured by a camera.
(5) The information provision device according to any of the above (1) to (4) wherein the driver data is an image of a face of the driver captured by a driver monitor camera.
(6) A display method displaying information to be provided to a driver of a vehicle on an information display screen by a control device, the display method comprising detecting a positional relationship of the vehicle and an object present in a rear region of the vehicle based on surrounding data showing a situation in the surroundings of the vehicle, detecting a line-of-sight direction of the driver based on driver data showing the state of the driver, and displaying rear region information including the positional relationship at the information display screen in response to detecting that the driver is viewing a rear check device for checking the rear of the vehicle based on the line-of-sight direction of the driver.
(7) A non-transitory computer storage medium containing a computer program for a control device controlling displayed content of the information display screen showing information to be provided to a driver of a vehicle, the computer program making the control device detect a positional relationship of the vehicle and an object present in a rear region of the vehicle based on surrounding data showing a situation in the surroundings of the vehicle, detect a line-of-sight direction of the driver based on driver data showing the state of the driver, and display rear region information including the positional relationship at the information display screen in response to detecting that the driver is viewing a rear check device for checking the rear of the vehicle based on the line-of-sight direction of the driver.

According to these aspects of the present disclosure, it is possible to provide information on an object present in a rear region of a vehicle at a suitable timing when the driver desires to confirm the rear of the vehicle.

### BRIEF DESCRIPTION OF DRAWINGS

FIG. 1 is a system schematic view of a vehicle provided with a display device according to one embodiment of the present disclosure.

FIG. 2 is a view showing a hardware configuration of a control device.

FIG. 3 is a flow chart explaining details of information provision processing performed at a processing part of a control device.

FIG. 4 is a view showing one example of a displayed image to be displayed on an information display screen.

### DESCRIPTION OF EMBODIMENTS

Below, referring to the drawings, embodiments of the present disclosure will be explained in detail. Note that, in the following explanation, similar component elements are assigned the same reference notations.

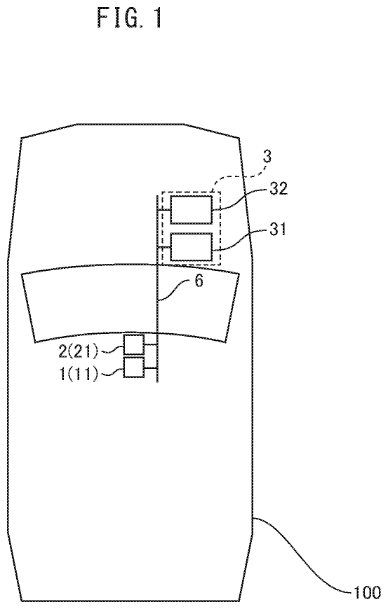

FIG. 1 is a system schematic view of a vehicle 100 provided with a display device 3 according to one embodiment of the present disclosure.

The vehicle 100 is provided with a surrounding sensor 1, driver sensor 2, and information provision device 3. The surrounding sensor 1, driver sensor 2, and information provision device 3 are respectively connected to be able to communicate through an internal vehicle network 6 compliant with the standards of a controller area network, vehicle-mounted Ethernet, etc.

The surrounding sensor 1 is a sensor for generating surrounding data showing the situation in the surroundings of the vehicle. In the present embodiment, as the surrounding sensor 1, a rear camera 11 is provided able to capture a region including the direct rear, right rear side, and left rear side of the vehicle 100 (below, “rear region of vehicle”). The rear camera 11 captures the rear region of the vehicle by a predetermined frame rate (for example, 10 Hz to 40 Hz) and generates a rear region image in which that rear region is shown. The rear camera 11 sends the generated rear region image through the internal vehicle network 6 to the control device 32 of the information provision device 3 each time its generates a rear region image.

Note that instead of the rear camera 11 or together with the rear camera 11, a distance measurement sensor measuring the distance to a vehicle, pedestrian, or other object present in the rear region of the vehicle may be provided as the surrounding sensor 1. As an example of a distance measurement sensor, for example, a lidar (light detection and ranging) device emitting a laser beam and measuring distance based on the reflected beam, a millimeter wave radar sensor emitting an electromagnetic wave and measuring distance based on the reflected wave, etc. may be mentioned.

The driver sensor 2 is a sensor for generating driver data showing the state of the driver. In the present embodiment, as the driver sensor 2, a driver monitor camera 21 able to capture a face of the driver is provided. The driver monitor camera 21 captures the face of the driver by a predetermined frame rate (for example, 10 Hz to 40 Hz) and generates a face image showing the face of the driver. The driver monitor camera 21 sends the generated face image of the driver through the internal vehicle network 6 to the control device 32 of the information provision device 3 each time its generates the face image.

The information provision device 3 is provided with an information display screen 31 and a control device 32 controlling the displayed content of the information display screen 31.

The information display screen 31 maybe various types of displays placed at positions which the driver of the vehicle 100 can view such as a meter display, center display, or heads up display and displays information corresponding to a display signal output from the later explained processing part 323 of the control device 32 (for example, text information or image information).

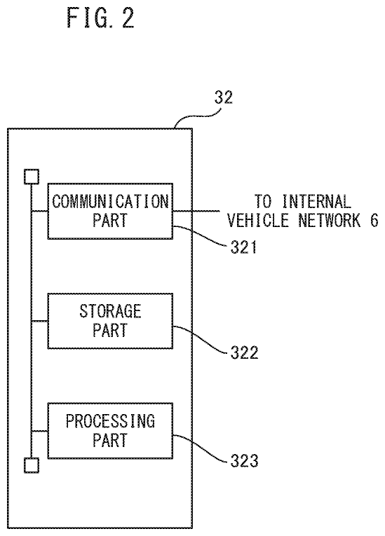

FIG. 2 is a view showing a hardware configuration of the control device 32.

The control device 32 is provided with a communication part 321, storage part 322, and processing part 323.

The communication part 321 is provided with an interface circuit for connecting the control device 32 to the internal vehicle network 6. The communication part 321 supplies data received from the outside (surrounding data, driver data, etc.) to the processing part 323. Further, the communication part 321 outputs a display signal output from the processing part 323 to the information display screen 31.

The storage part 322 has an HDD (hard disk drive) or SSD (solid state drive), optical recording medium, semiconductor memory, or other storage medium and stores various types of computer programs, data, etc. used for processing at the processing part 323.

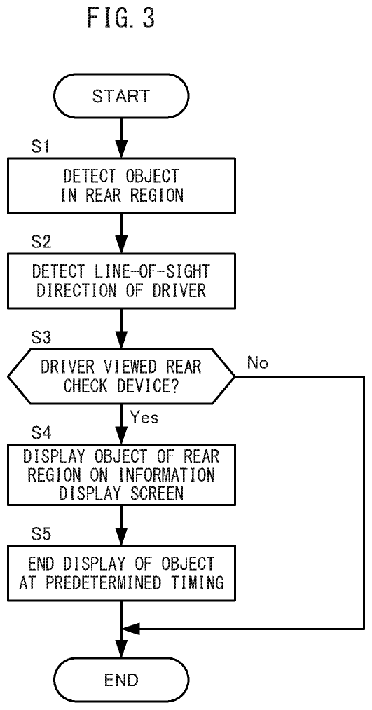

The processing part 323 has one or more CPUs (central processing units) and their surrounding circuits. The processing part 323 runs various types of computer programs stored in the storage part 322 and comprehensively controls the overall operations of the information provision device 3. For example, it is a processor. Below, referring to FIG. 3, details of the information provision processing performed at this processing part 323 will be explained.

FIG. 3 is a flow chart for explaining details of information provision processing performed at the processing part 323 of the control device 32.

At step S1, the control device 32 detects the type of the object (passenger car, truck, two-wheeled vehicle, pedestrian, etc.) present in the rear region of the vehicle 100 and the positional relationship between the vehicle 100 and object based on the surrounding data received from the surrounding sensor 1, specifically the rear region image received from the rear camera 11. These detection operations for example can be performed by successively inputting rear region images received from the rear camera 11 to a discriminator. The discriminator, for example, can be made a convolutional neural network (CNN) having a plurality of convolution layers connected in series from the input side to the output side.

At step S2, the control device 32 detects the line-of-sight direction of the driver based on the driver data received from the driver sensor 2, specifically the face image of the driver received from the driver monitor camera 21. The line-of-sight direction of the driver can, for example, be detected by successively performing image processing on a face image received from the driver monitor camera 21 to detect the position of a purkinje image (corneal reflected image) serving as a reference point and the position of the center of the pupil serving as a moving point and detecting the line-of-sight direction based on the positional relationship of the purkinje image and the pupil center (position of moving point with respect to reference point).

At step S3, the control device 32 judges whether the driver has viewed the rear check device for checking the rear of the vehicle 100 based on the line of sight of the driver. As the rear check device, for example, a room mirror or side mirror can be mentioned. In the present embodiment, both a room mirror and side mirror are made rear check devices, but either of these may also be made the rear check device.

The control device 32 proceeds to the processing of step S4 if it can be judged from the line-of-sight direction of the driver that the driver has viewed a rear check device. On the other hand, the control device 32 ends the current processing if it cannot be judged from the line-of-sight direction of the driver that the driver has viewed a rear check device.

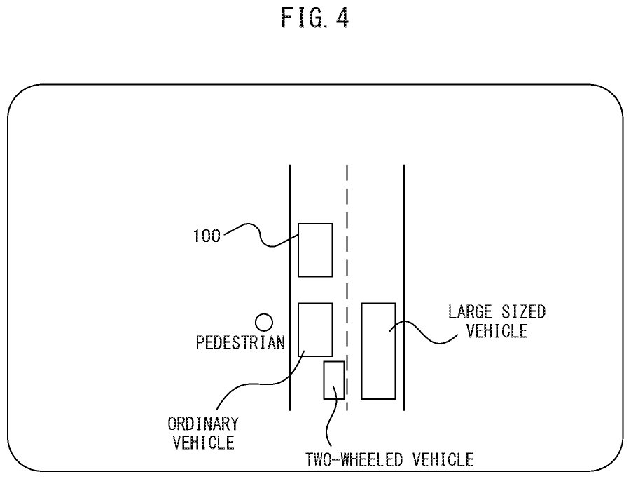

At step S4, the control device 32 makes rear region information including the type of the object present at the rear region of the vehicle 100 and the positional relationship of the vehicle 100 and the object be displayed on the information display screen 31. In the present embodiment, the control device 32, as shown in FIG. 4, shows, as the displayed image made to be displayed at the information display screen 31, an image viewing the vehicle 100 and an object of its rear region from above. Due to this, the type of the object and the positional relationship between of the vehicle 100 and object are shown, but the displayed image is not limited to such an image.

At step S5, the control device 32 ends the display of the rear region information at a predetermined timing. The predetermined timing can be made for example after the elapse of a predetermined time period from when displaying the rear region information. Further, for example, it is possible to make it any timing (right after or after the elapse of a predetermined time) after displaying the rear region information and then judging based on the line-of-sight direction of the driver that the driver has viewed a meter display (that is, after being able to judge that the driver has checked the rear region information).

The information provision device 3 according to the present embodiment explained above is provided with an information display screen 31 for displaying information to be provided to the driver of the vehicle 100 and a control device 32 controlling the displayed content of the information display screen 31.

Further, the control device 32 is configured to detect the positional relationship between the vehicle 100 and an object present in the rear region of the vehicle 100 based on surrounding data showing the situation of the surroundings of the vehicle 100 (for example, an image of the rear region of the vehicle 100 captured by the rear camera 11), detect the line of sight of the driver based on driver data showing the state of the driver (for example, an image of the face of the driver captured by the driver monitor camera 21), and display rear region information including the positional relationship of the vehicle 100 and the object present in that rear region on the information display screen 31 in response to detecting that the driver is viewing a rear check device for checking the rear of the vehicle 100 based on the line-of-sight direction of the driver.

Due to this, the driver can just turn his line of sight to a rear check device such as a room mirror or side mirror to check for the presence of any object present in the rear region of the vehicle 100 and the position of that object through the information display screen 31.

Therefore, according to the present embodiment, it is possible to provide the driver with information on an object present in the rear region of the vehicle 100 at a suitable timing when the driver desires to check the rear of the vehicle 100. For this reason, for example, even if there were an object present in the rear region which could not be recognized due to being missed because of being present at a dead angle of a mirror etc. or other reason, it is possible to provide the driver with information on the object at a suitable timing. Further, according to the present embodiment, it is no longer necessary to look back so as to turn the line of sight toward the rear when checking the rear of the vehicle 100, so it is also possible to easily and safely check the rear of the vehicle 100.

Further, the control device 32 is configured to end the display of the rear region information when, while displaying rear region information on the information display screen 31, detecting based on the line-of-sight direction of the driver that the driver has viewed the information display screen or after a predetermined time period has elapsed from when detecting that.

Due to this, it is possible to keep from ending the display of the rear region information before the driver checks that information.

Note that in the present embodiment, the rear region information includes the positional relationship between the vehicle 100 and an object present at a rear region of the vehicle 100 plus information relating to the type of the object. Due to this, it is possible to provide more accurate information of the rear region to the driver.

Above, an embodiment of the present disclosure was explained, but the above embodiment only shows part of the examples of application of the present disclosure and is not intended to limit the technical scope of the present disclosure to the specific constitution of the embodiment.

For example, in the above embodiment, the computer program (information provision processing) run at the control device 32 of the information provision device 3 maybe provided in a computer readable portable storage medium such as a semiconductor memory, magnetic recording medium, or optical recording medium.

1. An information provision device comprising:
an information display screen configured to display information to be provided to a driver of a vehicle; and
a control device configured to control displayed content of the information display screen, wherein the control device is configured to:
detect a positional relationship of the vehicle and an object present in a rear region of the vehicle based on surrounding data showing a situation in the surroundings of the vehicle;
detect a line-of-sight direction of the driver based on driver data showing the state of the driver; and
display rear region information including the positional relationship at the information display screen in response to detecting that the driver is viewing a rear check device for checking the rear of the vehicle based on the line-of-sight direction of the driver.

2. The information provision device according to claim 1, wherein, after displaying rear region information on the information display screen, the control device is configured to end display of the rear region information in response to detecting that the driver viewed the information display screen based on the line-of-sight direction of the driver or a predetermined time period elapsing after detecting that the driver viewed the information display screen.

3. The information provision device according to claim 1, wherein rear region information includes information relating to the type of the object.

4. The information provision device according to claim 1, wherein the surrounding data is an image of the rear region of the vehicle captured by a camera.

5. The information provision device according to claim 1, wherein the driver data is an image of a face of the driver captured by a driver monitor camera.

6. A display method displaying information to be provided to a driver of a vehicle on an information display screen by a control device,
the display method comprising:
detecting a positional relationship of the vehicle and an object present in a rear region of the vehicle based on surrounding data showing a situation in the surroundings of the vehicle;
detecting a line-of-sight direction of the driver based on driver data showing the state of the driver; and
displaying rear region information including the positional relationship at the information display screen in response to detecting that the driver is viewing a rear check device for checking the rear of the vehicle based on the line-of-sight direction of the driver.

7. A non-transitory computer storage medium containing a computer program for a control device controlling displayed content of the information display screen showing information to be provided to a driver of a vehicle,
the computer program making the control device
detect a positional relationship of the vehicle and an object present in a rear region of the vehicle based on surrounding data showing a situation in the surroundings of the vehicle,
detect a line-of-sight direction of the driver based on driver data showing the state of the driver, and
display rear region information including the positional relationship at the information display screen in response to detecting that the driver is viewing a rear check device for checking the rear of the vehicle based on the line-of-sight direction of the driver.
